(19) United States
(12) Patent Application Publication
(10) Pub. No.: US 2013/0068502 A1
(43) Pub. Date: Mar. 21, 2013

(54) DRY DOOR GROMMET

(71) Applicants: Gary J. Law, Auburn Hills, MI (US); Robin C. Meyer, Macomb, MI (US); Keera A. Riddick, West Bloomfield, MI (US); Constantine J. Nicolopoulos, Columbus, MI (US); Dion Wujcik, Westland, MI (US)

(72) Inventors: Gary J. Law, Auburn Hills, MI (US); Robin C. Meyer, Macomb, MI (US); Keera A. Riddick, West Bloomfield, MI (US); Constantine J. Nicolopoulos, Columbus, MI (US); Dion Wujcik, Westland, MI (US)

(73) Assignee: Chrysler Group LLC, Auburn Hills, MI (US)

(21) Appl. No.: 13/621,394

(22) Filed: Sep. 17, 2012

Related U.S. Application Data
(60) Provisional application No. 61/536,176, filed on Sep. 19, 2011.

(51) Int. Cl. H02G 3/22

(52) U.S. Cl. 174/152 G

(57) ABSTRACT

A protective wiring grommet that prevents water or debris from entering the grommet. The grommet includes a lower member, an intermediate member coupled to the lower member; and an upper member coupled to the intermediate member. The lower member, the intermediate member, and the upper member collectively define a wiring trough, a wiring conduit in communication with the trough that extends substantially orthogonal to the wiring trough in a first direction, and a wiring feed tube in communication with the wiring conduit that extends substantially orthogonal to the wiring conduit in a second direction. Such a configuration assists in routing wiring within the vehicle and through the grommet, to reduce manufacturing costs and efforts, as well as maintenance costs and efforts.

### CROSS-REFERENCE TO RELATED APPLICATION

This invention claims the benefit of U.S. Provisional Ser. No. 61/536,176, filed Sep. 19, 2011.

### FIELD

The present invention relates to a wiring grommet for a vehicle.

### BACKGROUND

Many vehicle doors, especially front vehicle doors, have multiple electrical components mounted therein. These electrical components include, for example, lights, speakers, door locks, and window actuators, among others. The wiring for these components is typically bundled together to form a wiring harness to be routed from the interior cavity of the door to the vehicle body, to which the wiring is then connected with the electrical system of the vehicle. When the vehicle door is opened, the wiring harness is exposed to various elements, the wiring may be prone to becoming tangled, and the wiring is at risk of coming into contact with metal that forms the door and/or the vehicle body. To protect the wiring, therefore, there generally is provided a wiring grommet that provides a protective passage for the wiring and harness. Grommets, however, are generally not designed to direct wiring in an efficient manner before installation in the vehicle, nor are grommets designed to be easily removed from the vehicle during maintenance.

### SUMMARY

The present disclosure provides a protective wiring grommet that prevents water or debris from entering the grommet. The grommet includes a lower member, an intermediate member coupled to the lower member; and an upper member coupled to the intermediate member. The lower member, the intermediate member, and the upper member collectively define a wiring trough, a wiring conduit in communication with the trough that extends substantially orthogonal to the wiring trough in a first direction, and a wiring feed tube in communication with the wiring conduit that extends substantially orthogonal to the wiring conduit in a second direction. Such a configuration assists in routing wiring within the vehicle and through the grommet, to reduce manufacturing costs and efforts, as well as maintenance costs and efforts.

Further areas of applicability of the present disclosure will become apparent from the detailed description, drawings and claims provided hereinafter. It should be understood that the detailed description, including disclosed embodiments and drawings, are merely exemplary in nature, intended for purposes of illustration only, and are not intended to limit the scope of the invention, its application, or use. Thus, variations that do not depart from the gist of the invention are intended to be within the scope of the invention.

### BRIEF DESCRIPTION OF THE DRAWINGS

FIG. 1 is a perspective view of a wiring grommet according to a principle of the present disclosure attached to a vehicle body;

FIG. 2 is a perspective view of a wiring grommet according to a principle of the present disclosure;

FIG. 3 is a perspective view of a wiring grommet according to a principle of the present disclosure;

FIG. 4 is a front perspective view of a wiring grommet according to a principle of the present disclosure, with various portions of the wiring grommet removed for clarity;

FIG. 5 is a side perspective view of a wiring grommet according to a principle of the present disclosure; and

FIG. 6 is a top perspective view of a wiring grommet according to a principle of the present disclosure.

### DETAILED DESCRIPTION

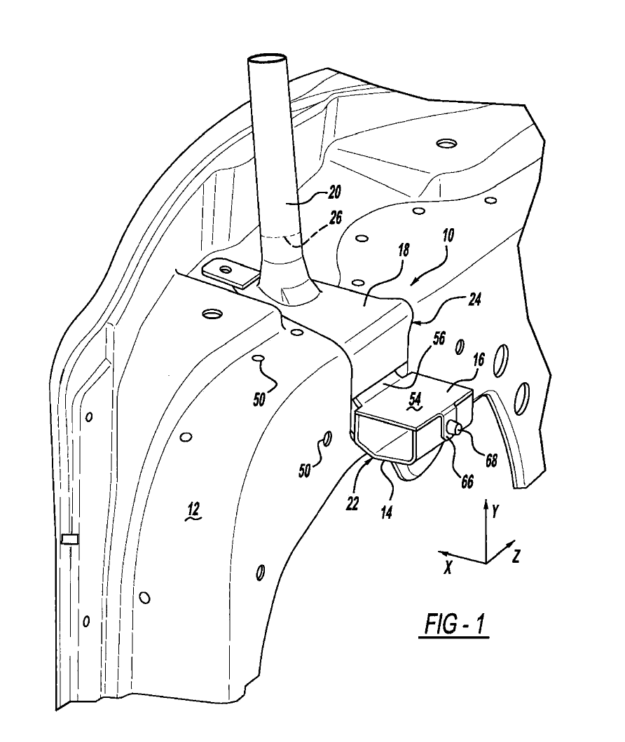

FIG. 1 illustrates a wiring grommet 10 fixed to a vehicle body 12. FIG. 1 illustrates wiring grommet 10 fixed to a driver side of vehicle body 12, but it should be understood that wiring grommet 10 may be used at another portion of the vehicle, for example at a passenger side of vehicle body 12 as well.

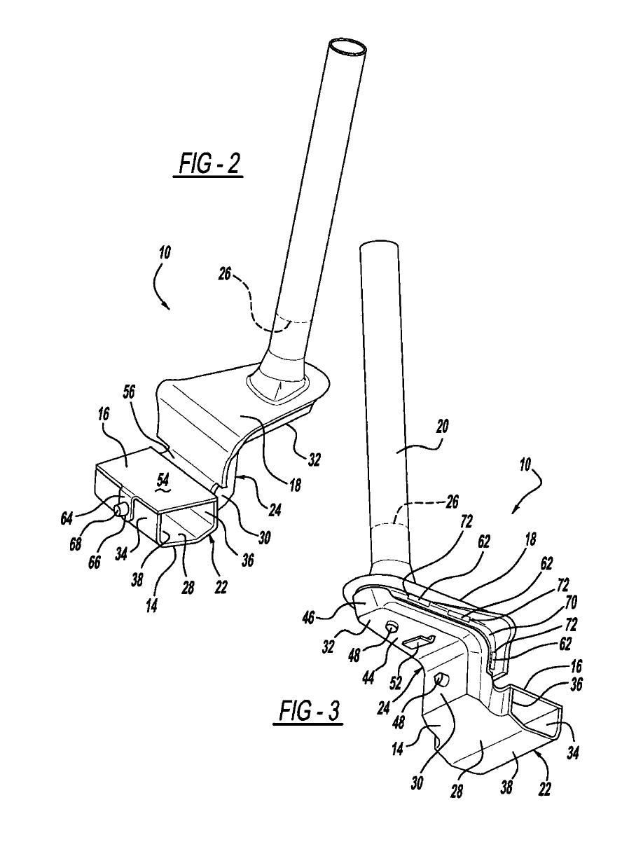

Now referring to FIGS. 2-6, wiring grommet 10 is illustrated in more detail. Wiring grommet 10 is a three-piece assembly that may be fabricated, formed, molded from metals or plastic materials such as, for example, polystyrene, polyamide, polyvinyl chloride, or the like. Forming wiring grommet 10 from the above-noted materials provides wiring grommet 10 with rigidity, while maintaining a degree of flexibility that assists in installing wiring grommet 10 during production of a vehicle as will be described below.

Wiring grommet 10 includes lower member 14, an intermediate member 16, and an upper member 18. Collectively, lower member 14, intermediate member 16, and upper member 18 define a feed tube hose 20, a trough 22, and a conduit 24. As illustrated in FIG. 1, when wiring grommet 10 is installed in a vehicle, trough 22 will extend in the z-axis direction, conduit 24 will extend in the x-axis direction, and feed tube 20 will extend in the y-axis direction. Trough 22, conduit 24, and feed tube 20 are each in communication to define a wiring feedthrough for the wiring that lead from vehicle body 12 into, for example, a vehicle door (not illustrated).

Feed tube hose 20 is illustrated in the drawings as being longer than when wiring grommet 10 is installed in a vehicle. In this regard, feed tube hose 20 most often will terminate at 26 when installed in a vehicle, and a flexible accordion-like rubber hose (not shown) that feeds the wiring from grommet 10 into the vehicle door will be coupled thereto. Regardless, feed tube hose 20 is a tubular member defined by upper member 18, and formed from either the plastic materials listed above, or a rubber- or polymeric-based material that assists in sealing wiring grommet 10.

In a particular embodiment, upper member 18 defining feed tube hose 20 is formed from a rubber- or polymeric-based sealing material that precludes the invasion of water or debris into wiring grommet 10. Further, in an alternative embodiment, feed tube hose 20 may be formed to have a length as illustrated in the figures, which eliminates the need for the flexible accordion-like rubber hose. Instead of being a smooth tubular member, however, feed tube hose 20 could be molded to be accordion-like to provide increased flexibility to feed tube hose 20. Such a configuration reduces manufacturing costs due to ease of installation, and due to a decrease in the number of elements required in installing the wiring system of the vehicle.

Lower member 14 is fixed to vehicle body 12 and defines bottom portions of trough 22 and conduit 24. In this regard, lower member 14 includes a first portion 28 that defines a bottom of trough 24, a second portion 30 that defines an opening 31 of conduit 24, and a third portion 32 that defines an exit of conduit 24. First portion 28 of lower member 14 defines sidewalls 34 and 36, and a base 38 of trough 22. Sidewalls 36, as best illustrated in FIG. 3, merge into second portion 30 of lower member 14, which defines the opening 31 of conduit 24.

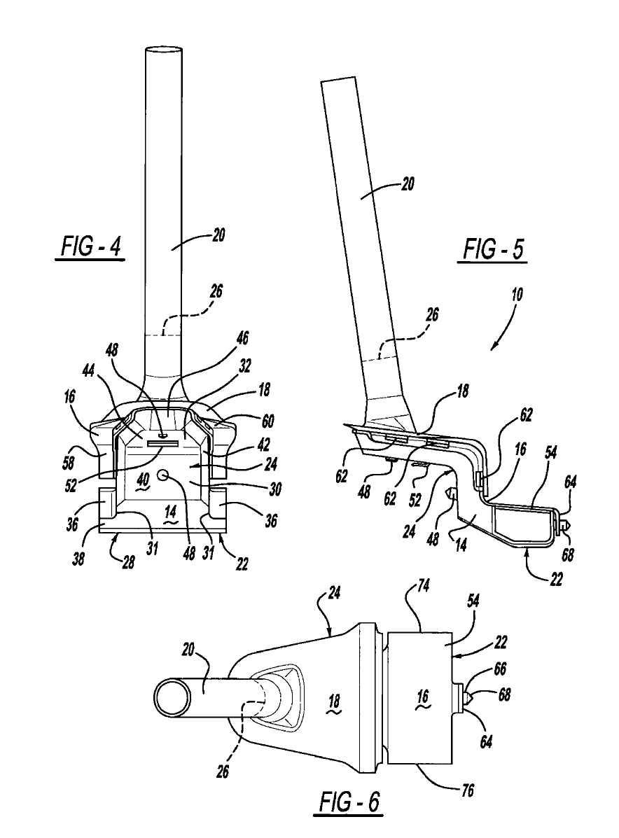

Second and third portions 30 and 32 of lower member 14 define conduit 24. As best illustrated in FIGS. 4 and 5, second portion 30 is defined by a bottom 40 that is bordered on each side by sidewalls 42. Bottom 40 is arranged substantially orthogonal to base 38 of trough 22. Bottom 40 merges into a support surface 44 of third portion 32, and is arranged substantially orthogonal to bottom 40 of second portion 30. Surrounding support surface 44 are sidewalls 46.

To fix lower member 14 to vehicle body 12, lower member 14 includes a pair of projections 48 that engage apertures (not shown) formed in vehicle body 12. Although projections 48 are not illustrated in the figures as being engaged with apertures 50, the apertures that are engaged by projections 48 are similar to apertures illustrated in FIG. 1. Regardless, apertures 48 project outward from support surface 44 of third portion 32 of lower member 14.

Lower member 14 also includes an attachment device in the form of a flange clip 52 disposed between projections 48 that engages an elongated aperture (not shown) formed in vehicle body 12. As noted above, wiring grommet 10 is formed of materials that provide rigidity to wiring grommet 10, while maintaining flexibility. Accordingly, to fix wiring grommet 10 to vehicle body 12, lower member 14 is first manipulated to engage flange clip 52 with the elongated aperture of vehicle body 12 by slightly bending lower member 14. After flange clip 52 is coupled to the elongated aperture, projections 48 may be engaged with their corresponding apertures formed in vehicle body 12 to secure wiring grommet 10 to vehicle body 12.

Disposed between lower member 14 and upper member 18 is intermediate member 16. Intermediate member 16 includes a trough cover 54 that merges into a conduit cover 56 that includes a first member 58 that covers bottom 40 of second portion 30 and a second member 60 that covers support surface 44 of third portion 32 of lower member 14. On opposing sides of intermediate member 16 are flanges 62 that couple upper member 18 to intermediate member 16. To couple intermediate member 16 to lower member 14, intermediate member 16 is provided with a lip 64 having an aperture 66. Aperture 66 is engaged by a projection 68 that extends outward from sidewalls 34 of first portion 28 of lower member 14.

To ensure that wiring grommet 10 is sealed from invasion by water or debris, upper member 18 includes a skirt 70. Skirt 70 includes slots 72 that engage with flanges 62 to secure upper member 18 to intermediate member 16. Due to skirt 70, water or debris is prevented, or at least substantially minimized, from invading conduit 24 of wiring grommet 10. It should be understood that although upper member 18 including skirt 70 is illustrated as only covering conduit 24, the present disclosure should not be limited thereto. In this regard, when wiring grommet 10 is installed in a vehicle, only feed tube hose 20 and upper member 18 will be visible due to the remaining structure (e.g., trough 22) of wiring grommet 10 being covered by an interior trim piece (not shown) that is fixed to vehicle body 12 at apertures 50. Due to the absence of the interior trim piece, water or debris would most likely be able to invade wiring grommet 10 at the exposed upper member 18. Regardless, it should be understood that upper member 18 may be extended to cover and engage with trough 22, if desired.

To install wiring into wiring grommet 10, the wiring (not shown) is first fed through feed tube hose 20. After feeding the wiring through feed tube hose 20, the wiring is inserted into conduit 24 and pulled into trough 22. From trough 22, the wiring may be pulled out from trough 22 through either exit 74 or exit 76, depending on the location of the module or system to which a particular wiring is to be connected. Slots 72 of upper member 18 may then be secured to flanges 62 of intermediate member 16 to complete wiring grommet 10.

Wiring grommet 10 provides a simple and rigid support structure for the wiring. Due to trough 22, the wiring is directionally bundled, which assists in installing wiring grommet 10 during manufacture of the vehicle, or during maintenance thereof. This reduces manufacturing costs and maintenance time. Due to wiring grommet 10 being formed of rigid, but flexible plastic, wiring grommet 10 also serves as a protective shield for the wiring during installation.

What is claimed is:

1. A wiring grommet, comprising:
a lower member;
an intermediate member coupled to the lower member; and
an upper member coupled to the intermediate member,
wherein the lower member, the intermediate member, and the upper member collectively define a wiring trough, a wiring conduit in communication with the trough that extends substantially orthogonal to the wiring trough in a first direction, and a wiring feed tube in communication with the wiring conduit that extends substantially orthogonal to the wiring conduit in a second direction.

2. The wiring grommet of claim 1, wherein the upper member seals the wiring grommet.

3. The wiring grommet of claim 1, wherein the first and second directions are different.

4. The wiring grommet of claim 1, wherein each of the lower member, the intermediate member, and the upper member are formed of the same material.

5. The wiring grommet of claim 1, wherein the lower member and the intermediate member are formed of the same material, and the upper member is formed of a different material.

6. The wiring grommet of claim 5, wherein the lower member and the intermediate member are formed from a plastic material, and the upper member is formed from a rubber or polymeric-based material.

7. The wiring grommet of claim 1, wherein the lower member defines a base of the trough and the conduit.

8. The wiring grommet of claim 7, wherein the intermediate member covers the trough and the conduit.

9. The wiring grommet of claim 1, wherein the lower member includes an attachment device for attaching the wiring grommet to a body.

10. A wiring grommet for a vehicle, comprising:
a wiring trough extending in the z-axis direction;
a wiring conduit extending in the x-axis direction; and
a wiring feed tube extending in the y-axis direction,
wherein the wiring trough, the wiring conduit, and the wiring feed tube are each in communication to define a wiring feed-through.

11. The wiring grommet of claim 10, wherein the wiring trough, the wiring conduit, and the wiring feed tube are collectively defined by a lower member, an intermediate member coupled to the lower member, and an upper member coupled to the intermediate member.

12. The wiring grommet of claim 11, wherein the upper member seals the wiring grommet.

13. The wiring grommet of claim 11, wherein each of the lower member, the intermediate member, and the upper member are formed of the same material.

14. The wiring grommet of claim 11, wherein the lower member and the intermediate member are formed of the same material, and the upper member is formed of a different material.

15. The wiring grommet of claim 14, wherein the lower member and the intermediate member are formed from a plastic material, and the upper member is formed from a rubber or polymeric-based material.

16. The wiring grommet of claim 11, wherein the lower member defines a base of the trough and the conduit.

17. The wiring grommet of claim 16, wherein the intermediate member covers the trough and the conduit.

18. The wiring grommet of claim 11, wherein the lower member includes an attachment device for attaching the wiring grommet to a body.
